(19) United States
(12) Patent Application Publication
(10) Pub. No.: US 2024/0191043 A1
(43) Pub. Date: Jun. 13, 2024

(54) DISPERSION OF NANOPARTICLES IN A POLYMERIC MATRIX

(71) Applicant: LANDA LABS (2012) LTD., Rehovot (IL)

(72) Inventors: Sagi ABRAMOVICH, Ra'anana (IL); Omer ASHKENAZI, Kfar Gibton (IL); Yehuda TOW, Moshav Na'ama (IL)

(73) Assignee: LANDA LABS (2012) LTD., Rehovot (IL)

(21) Appl. No.: 18/553,739

(22) PCT Filed: Apr. 5, 2022
(86) PCT No.: PCT/IB2022/053139

§ 371 Date: Oct. 3, 2023

(30) Foreign Application Priority Data
Apr. 9, 2021 (GB) 2105077.8

(51) Int. Cl. C08J 3/215; C08J 3/20; C08K 3/04; C08K 3/08; C08K 3/22; C08K 3/36

(52) U.S. Cl. CPC C08J 3/215; C08J 3/201; C08K 3/04; C08K 3/08; C08K 3/22; C08K 3/36; C08J 2363/04; C08J 2367/02; C08J 2367/06; C08K 2003/0843; C08K 2003/0856; C08K 2003/2241; C08K 2201/003; C08K 2201/005; C08K 2201/01; C08K 2201/011

(57) ABSTRACT

The present disclosure relates to a method for stably dispersing nanoparticles of a material in a curable polymer, the method comprising: a) providing a curable pre-polymer; b) providing particles of the material; and c) compounding the curable pre-polymer and the particles at a compounding temperature sufficiently high to obtain a curable melt mixture and sufficiently low for the curable melt mixture to develop a pre-determined viscosity upon compounding. The compounding is performed by applying a shear force to the heated curable melt mixture, whereby nanoparticles are formed from the particles, the viscosity of the melt being such that the nanoparticles remain dispersed in the mixture.

### CROSS-REFERENCE TO RELATED APPLICATIONS

This application claims Paris Convention priority from Great-Britain patent application No. 2105077.8, filed on Apr. 9, 2021, the contents of which are incorporated by reference in their entirety as if fully set forth herein.

### FIELD

The present disclosure relates generally to methods for the preparation of nanoparticles and their dispersion in a curable polymeric matrix, and in particular to the stable dispersion of functional nanoparticles.

### BACKGROUND

Nanoparticles, which can also be referred to as nanocrystals when having a crystalline structure, typically have a longest characterizing dimension (e.g., a diameter) between 1 and 100 nanometer (nm). Such particles have numerous applications in diverse fields such as cosmetics, diagnostics, drug delivery, electronics, imaging, printing, etc. In some fields, their effect can be considered purely ornamental, whereas in others they contribute to functional aspects of the end-product.

Among the factors affecting the role the nanoparticles can play in any industry, are the materials from which they are made, with which they are coated, or in which they are dispersed; and their morphology, crystallinic structure, particle size, range and type of distribution (e.g., monodisperse). For instance, control of grain size can allow tuning the properties (e.g., bandgap energy, optical, magnetic, etc.) of a specific material for a particular application, and specific particle size distribution may favor predetermined uses. Both can be used to optimize material performance.

The applications of nano-sized particles in many aspects of industry and commercial products require efficient and economical ways to prepare such particles in high quality, so they may exhibit their desired properties, advantageously in a manner stable over time. Conventional techniques for nanoparticle production involve either a bottom-up approach, assembling the nanoparticles by synthesis from precursors appropriate to form the desired material, or a top-to-bottom approach, size-reducing the material from which the particles are to be made to the desired size. The two approaches are not mutually exclusive and nanoparticles may first be synthesized (e.g., to include materials not available as bulk), and later milled to disperse aggregates of nanoparticles (or thin layers of the desired material) that may have formed during the synthesis. When the synthetic and size-reducing approaches are combined in view of a specific design of the nanoparticles, such as having a core-shell structure (e.g., quantum dots core-shells such as CdSe/ZnS and CdTe/CdS) which may not be obtained from down-sizing of a bulk, the process may unfortunately combine the weaknesses of both methods. Some nanoparticles may require a relatively high level of integrity to suitably perform their function, the external coating of the particle contributing to the function of the core. Such coat, shell or cap may be viewed as a “protective” layer, insulating the core (or conversely the dispersing medium) from external influences such as chemical stress (e.g., corrosion), physical stress, or any other undesired interference with the environment of the nanoparticles that would result in a reduction or loss of function.

The bottom-up synthetic approach, which can involve, for illustration, liquid solution, solid solution, sputtering and the like, is not always economical (e.g., when particles having a diameter of 10 nm or more are desired), nor feasible for all materials. Size reduction techniques have their own drawbacks in the formation of uniformly sized and stable dispersions of nanoparticles having the desired structure, thus jeopardizing the potency and/or reliability of the products and systems in which they can be employed.

For illustration, while high impact forces could be required to rapidly size-reduce a material to a desired size range, such forces may be deleterious to the properties sought for the nanoparticles. While reducing impact may maintain a desirable property (e.g., a crystalline structure), this may adversely affect economical production, or the obtaining of particles at the size and/or distribution necessary for their optimal function.

Moreover, some materials, regardless of the method used for their preparation as nanoparticles, may present additional challenges for their stable dispersion in a medium, as may be required for some applications. Consider, for illustration, magnetic materials which may exert attractive or repulsive forces depending on their respective polarities, or particles made from materials having a density relatively higher than their medium and which may therefore sediment, such properties may not enable their preparation as stable dispersions. Nanoparticles of magnetic materials can be used in numerous products, such as in magnetic recording media, read and write heads, RF (radio frequency) shields or absorbers as well as in a number of imaging, optical, electrical, diagnostic and medical methods and devices.

Stabilizing a dispersion of nanoparticles in a polymeric matrix by conventional means is challenging. Nanoparticles dispersed in a fluid medium are subject to Brownian motion, the action of molecular collisions between the particles and the fluid, which cause the particles to move in a random manner, eventually colliding with other particles, forming flocs or agglomerates, thus destabilizing the dispersion. Known methods for stabilizing nanoparticle dispersions seek to prevent such Brownian motion-induced collisions through the use of chemical “dispersants”, which operate by electrostatic repulsion, steric hindrance, or a combination of both, known as electro-steric stabilization. However, such stabilization methods require a substantial amount of dispersant, due to the relatively large surface area of nanoparticles. The weight ratio of dispersant to nanoparticles can sometimes be as high as 2:1, and more, which may in turn degrade the chemical or physical properties of the final product.

Thus, there remains a need to find a method for preparing nanoparticles that are stably dispersed in the medium required for their intended use, a function of the nanoparticles not being adversely affected by the process, which could advantageously be performed without employing substantial amounts of chemical dispersants.

### BRIEF DESCRIPTION OF THE DRAWINGS

Some embodiments of the disclosure will now be described further, by way of example, with reference to the accompanying figures, where like reference numerals or characters indicate corresponding or like components. The description, together with the figures, makes apparent to a person having ordinary skill in the art how some embodiments of the disclosure may be practiced. The figures are for the purpose of illustrative discussion and no attempt is made to show structural details of an embodiment in more detail than is necessary for a fundamental understanding of the disclosure. For the sake of clarity and convenience of presentation, some objects depicted in the figures are not necessarily shown to scale.

In the Figures:

FIG. 1 schematically display different manufacturing stages for the preparation of nanoparticles dispersed in a polymeric material.

FIGS. 2A and 2B show the size distribution of nanoparticles that may be obtained by a method as depicted in FIG. 1.

FIG. 3 shows the XRD spectra of a material dispersed according to the present teachings.

### DETAILED DESCRIPTION

The object of the present disclosure is to provide a method for preparing nanoparticles that inter alia overcomes the shortcomings of the prior art. In particular, the present disclosure seeks to disperse the nanoparticles in a medium comprising a curable polymer, the method advantageously allowing the particles to remain stably dispersed in the polymer once cured. The cured product within which the nanoparticles are dispersed can also be referred to as a polymer or polymeric matrix.

Polymers, and their building blocks known as monomers, oligomers or shorter polymers, are broadly divided into thermoset and thermoplastic, which are differentiated based on their behavior upon application of heat. Thermosetting polymers, and precursors thereof also referred to as “pre-polymers”, irreversibly strengthen when heated, as a result of their three-dimensional polymerization, and cannot be remolded after the initial forming of the cross-linked structure, while thermoplastics can be reheated, remolded, and cooled as necessary without causing any substantial chemical changes.

While the difference between these two classes of materials is illustrated with thermal activation of their polymerization, this need not be the sole mechanism triggering the formation of the polymerized polymers, which may alternatively result, for example, from radiation, moisture etc. Regardless of the mechanism of polymerization of thermosetting polymers, their uncured precursors may display a thermoplastic behavior before the right curing conditions (e.g., being above a curing temperature, being in presence of curing facilitators, etc.) are set for their polymerization. The present disclosure seeks to take advantage of this window of opportunity, during which the thermoset pre-polymers effectively behave as thermoplastic materials. In other words, the present disclosure is concerned with the “plastic” properties of pre-polymers in substantial absence of a trigger suitable for their curing. Regardless of the chemical nature of the polymers that may be ultimately produced upon sufficient exposure to adequate curing conditions, the pre-polymers that can be used, alone or in combination, to form upon curing the final polymers of a cured matrix can be herein referred to as “curable thermoplastic pre-polymers”.

In a first aspect, the disclosure provides a method for producing nanoparticles of a material and for stably dispersing the same in a curable polymer, the method comprising:
a) providing a curable thermoplastic pre-polymer;
b) providing particles of the material;
c) optionally providing a dispersant selected and adapted to disperse the particles in the curable pre-polymer;
d) compounding the curable pre-polymer, the particles and the optional dispersant at a temperature sufficiently high to obtain a melt mixture and sufficiently low for the melt mixture to develop a pre-determined viscosity upon compounding, the compounding conditions being insufficient to cure or fully cure the melt mixture;
   wherein the compounding is performed by applying substantially only a shear force to the melt mixture, the shear force being such that the particles are reduced to nanoparticles and the pre-determined viscosity being such that the reduced nanoparticles are dispersed in the mixture.

The “melt mixture” may alternatively be referred to as the “curable melt mixture”, its curability referring to its ability to be fully cured under conditions which differ from those applied during compounding. Minor curing cannot be ruled out even under compounding conditions deemed suitable, but such conditions should be adapted to the components of the melt mixture so as to prevent curing to an extent incompatible with future formation of the fully cured matrix.

As used herein, the term “producing nanoparticles” does not refer to de novo synthesis, nor necessarily to the break-up of a unique particle into fragments, but typically to the break-up of a particle, comprised of an aggregation or agglomeration of nanoparticles, into individual primary particles or small clusters thereof. Accordingly, the nanoparticles resulting from such disaggregation or deagglomeration are said to be “dispersed” in the mixture, if forming discrete, individual, particles, or small clusters, all being relatively uniformly spaced from one another. The viscosity of the curable melt mixture is of a sufficient degree to maintain the nanoparticles dispersed, preventing, reducing or delaying their sedimentation or reagglomeration until the mixture is cured, so as to form the three-dimensional polymeric network capable of permanently trapping the nanoparticles in the matrix. This is believed to be the case at a temperature of compounding, and more so as the temperature of the mixture is lowered and the viscosity accordingly increased, even to an extent the mixture is no longer a melt. The curing of the polymer matrix, which advantageously need not be performed immediately following compounding, can then fix the nanoparticles in their dispersed state over time.

The particles to be dispersed as nanoparticles according to the present teachings can be solid organic or inorganic materials of any desired type. Generally, the material associated with the particles or nanoparticles being used or prepared in the present disclosure is the one prominently linked with the intended role of the nanoparticles in the polymeric matrix. For illustration, if the particles are made of a first material coated with a second material, the particles are typically said to be of the first material. By way of non-limiting examples, the particles made of a material which may benefit from the present teaching may include, consist, mainly consist, or consist essentially of a material selected from a group comprising metals (e.g., Ag, Al, Au, B, Cd, Co, Cr, Cu, Fe, K, Mn, Mo, Ni, Pb, Pt, Sn, Ta, Ti, W, etc.), metal oxides (e.g., Ag₂O, Al₂O₃, BaTiO₃, Fe₂O₃, MgO, TiO₂, ZnO, etc.), alloys (e.g., alloys of at least two or at least three metals, such as Ag—Al, Ag—Au, Ag—Cu, Ag—Pd, Al—Mn, Al—Ni, Co—Cr—Mo, Cu—Cr, Cu—Sn, Cu—Zn, Fe—Co, Fe—Ni, Fe—Si, Fe—Cr—Co, Fr—Ni—Co, Mn—Zn, Ni—Ti, Ni—Cr—Co, Sn—Pb, stainless steel, etc.), ceramics (e.g., AlN, BC, BN, Cr₃C₂, SiC, TaC, TiB₂, WC, etc.), semiconductors (e.g., quantum dots such as made of Si, Ge, CdSe, PbSe, CdTe, and PbS CdSe, CdS, CdTe, ZnSe, ZnS, ZnTe, HgS, HgSe, HgTe, and ZnO), carbon-based materials (e.g., carbon black, graphene, graphene oxide (GO), carbon nanotubes (CNTs), fullerenes, etc.) or other organic nanoparticles (e.g., made of natural polymers such as cellulose, or synthetic polymers such as polyethylene terephthalate, aramid, etc.), and pigments. The particles are said to include a material if the material is the major constituent among others forming the particle (e.g., constituting 30 wt. % provided other compounds are present in a lower amount). In some embodiments, the particles consist, mainly consist, or consist essentially of a material if respectively containing at least 50%, at least 80%, or at least 95% of the material by weight of the particles. While the method is generally described in terms of dispersing particles of a material into nanoparticles of the same material, it may alternatively be used to disperse particles made of different materials. While the present method shall be described in more details with respect to an alloy of iron having magnetic properties, a metal oxide having UV-absorbing properties, and ceramic materials having thermo-conductive or mechanical reinforcing properties, these examples should not be construed as limiting the scope of the present invention.

The nanoparticles can be functional, their function within the polymer nanocomposite being, for instance, as mechanical reinforcers (e.g., fillers, modifiers of tensile strength, toughness, density, etc.), thermal conductors, thermal insulators, modifiers of thermal properties (e.g., increasing heat resistance by raising the temperature of thermal decomposition, modifying glass transition, softening, or melting temperature), electrical conductors, electrical insulators, radiation absorbers (e.g., UV-blockers, cut-off or band filter, RF absorbers, etc.), optical markers (e.g., coloring, luminescent or fluorescent materials), sensors or magnetic, to name a few, such functions being alternatively referred to as mechanical, thermal, electrical, optical, detecting, imaging, magnetic, etc. functions. Nanoparticles that may serve to provide detectable signal, being either a color detectable to the naked eye in the visible range or detectable using a suitable instrumentation (e.g., a UV-lamp) or any other type of indication measurable by an adapted sensing, diagnostic, or imaging device can for simplicity be said to fulfil a detecting function regardless of the field for which such detection would be beneficial. These functions, which have been classified for ease of association with a main effect of the particle, need not be exclusive one of another, and a same type of nanoparticles may provide to the polymer matrix in which they are dispersed different combinations of two or more properties, e.g., electro-optical ones.

Advantageously, the present method is sufficiently potent to disperse nanoparticles of a material having a density higher than the density of the polymer matrix in which they are to be dispersed. As most polymers have a density comprised between 0.9 and 1.5 g/cm³, in some embodiments, the dispersible particles can be made of a material having a density of more than 1.5 g/cm³, such as a density of 2.0 g/cm³ or more, a density of 2.2 g/cm³ or more, a density of 2.4 g/cm³ or more, a density of 2.6 g/cm³ or more, a density of 2.8 g/cm³ or more, a density of 3.0 g/cm³ or more, a density of 4.0 g/cm³ or more, or a density of 5.0 g/cm³ or more. The density of a material dispersible by the present method does not typically exceeds 25.0 g/cm³ and can be of 22.5 g/cm³ or less, or of 20.0 g/cm³ or less.

In some embodiments, the method further comprises providing at least one of a curing agent (e.g., cross-linkers, hardeners) and a curing accelerator (e.g., catalysts), such curing facilitators being selected and adapted to the curable pre-polymer. In some embodiments, the curing facilitator (or mixture thereof), as well as any other suitable additive(s), may be provided prior to or during compounding the various components. However, this is not essential and even if curing facilitators are desired to proceed to satisfactory polymerization of the matrix and entrapment of the dispersed nanoparticles in due time, such materials can be provided after compounding, for instance prior to curing of the melt mixture.

The timing of mixing any particular additive in the composition along the different steps of its manufacturing method may depend on the intended role of the material being added. For instance, a plasticizer that may facilitate compounding or an inhibitor that may delay curing can be added at any preceding step or during compounding. In contrast, agents which may prolong storage of the end product need not necessarily be blended at an early step and could alternatively be added at the end of the process.

In some embodiments, the particles and the dispersant, when included, are provided pre-mixed one with the other.

In some embodiments, the compounding is performed at a temperature sufficient to melt the pre-polymer and the other organic constituents of the mixture, for instance at a temperature above one or more of the glass transition temperature, the softening temperature or the melting temperature of the pre-polymer or at a temperature above one or more of the glass transition temperature, the softening temperature or the melting temperature of the melt mixture prepared with the pre-polymer, the compounding temperature being possibly equal to Tg, Ts or Tm of the pre-polymer or melt mixture therefrom. This temperature, however, need be sufficiently below curing temperature of the mixture, if heat curable, the compounding temperature preferably being lower by at least 20 C°, at least 30 C° or at least 50 C° from the temperature of curing. In some embodiments, the compounding is performed at at least one temperature between 30° C. and 200° C., between 50° C. and 150° C., between 60° C. and 130° C., between 70° C. and 120° C., or between 80° C. and 110° C. The compounding is said to be performed at at least one temperature, for instance at more than one temperature in these ranges, as the temperature may be varied during the compounding process so as to accommodate and/or control the changes in viscosity. The change in temperature may result from heat being applied to the compounding process and/or from heat resulting therefrom. For instance, the shear force may cause a raise in the temperature of the melt mixture being compounded. As used herein, the compounding temperature primarily refers to the temperature perceived and developed in the melt mixture and may secondarily serve to set the temperature of an external heater contributing to this compounding parameter. Such compounding conditions, which are provided in terms of a temperature being insufficient to cure or fully cure the melt mixture when the melt mixture is prone to heat-triggered polymerization, should not be construed as limiting when the polymerization is triggered by other than temperature. In such cases, the compounding conditions insufficient to cure or fully cure the melt mixture will be accordingly selected, e.g., to include relatively low humidity or none for moisture triggered polymerization, to block radiation for radiation triggered polymerization, and the like. Persons skilled in the art of polymerization can readily appreciate which compounding conditions can essentially prevent untimely curing of the melt whilst compounding is performed.

In some embodiments, the viscosity of the curable melt mixture is at least 0.1 kiloPascal-second (kPa·s), at least 0.5 kPa·s, at least 1 kPa·s, at least 2.5 kPa·s, at least 5 kPa·s, at least 10 kPa·s, at least 20 kPa·s, at least 50 kPa·s, or at least 100 kPa·s, at the temperature at which compounding is performed. Typically, the pre-determined viscosity of the melt mixture is adapted to the shear force being employed for compounding and does not exceed 1,500 kPa·s, or is at most 1,000 kPa·s, or at most 500 kPa·s, at the compounding temperature. The viscosity of the curable melt can be determined by standard methods using a viscometer or a rheometer adapted for the intended range of viscosities. Measurements can be performed according to the procedure described for instance in ASTM D4440.

In some embodiments, the shear force applied for compounding, can be provided by an extruder, such as a single-screw, an intermeshing or a non-intermeshing twin-screw extruder; by a high-shear kneader; by a roller mill, such as a two roll mill or a three roll mill; of by any equipment suitable for plastic compounding by application of a force being substantially only a shear force, and essentially devoid of an impact force.

The shear deformation of the polymer melt in which the nanoparticles are being dispersed is typically characterized by a shear rate of up to thousands of reciprocal seconds (sec⁻¹) at the compounding temperature. In some embodiments, the shear rate of the curable mixture being compounded is between 1 and 1,000 sec⁻¹, between 10 and 800 sec⁻¹, or between 15 and 500 sec⁻¹. The shear rate, strain, stress or force locally perceived by the mix and their effect on the dispersive mixing of the separated nanoparticles throughout the polymer matrix is influenced by a variety of factors relating to machine design and operation, together with material composition. While the shear force is technically distinct from the shear stress, the latter corresponding to the former divided by the surface area of the load being applied, the two terms are often used interchangeably. In instruments adapted for shearing, the parameter often monitored and adjusted to the materials, their relative concentrations and the operating conditions is the drive torque.

In some embodiments, the drive torque, which depends for instance on the diameter of an extruder screw or of a mill roll, which is applied to obtain a suitable shearing of the nanoparticles within the curable matrix is of at least 10 Newton·Meter (N·m), at least 10² N·m, or at least 10³ N·m. Typically, the torque of pilot instrumentation does not exceed 10⁶ N·m, and is generally of no more than 10⁵ N·m.

Without wishing to be bound by any particular theory, it is believed that shear force may suffice to break up “raw” or “crude” particles provided ab initio as agglomerates into smaller and smaller clusters having a secondary particle size within a desired range, without affecting the properties of the primary particles (e.g., avoiding deformation, cracks, or any other like alteration). In a particular embodiment, the “deagglomeration” or “deaggregation” achieved by a present method (or the nanoparticles produced thereby) is such that the particle size distribution of the nanoparticles is similar to the size distribution of its primary particles, which essentially correspond to the primary particles forming the crude particles. As the viscosity of the curable melt mixture is relatively high, even at the elevated temperature required for compounding of its constituents, its viscosity would only further increase as the melt is allowed to cool to room temperature circa 23° C. (or is actively cooled to any temperature below its Tm, Ts or further down below its Tg, if applicable). Under such conditions, Brownian motion can be sufficiently inhibited such that the nanoparticles dispersed by the high shear force will remain stably dispersed in the curable matrix.

If the curable mix is not readily used to form a fully cured shape, it can be stored for future use. For instance, once the curable mix has cooled down upon completion of the compounding step, it can be stored under conditions decreasing, delaying, or preventing its curing or further curing by the time it is to be used. When the mix is heat curable, the storage conditions can include relatively low temperature, such as deep freeze at −70° C., −20° C., or any other temperature suitable to maintain sufficient curing ability to the mix upon its thawing, preparation for use and curing into a cured product. When the mix is moisture curable, the storage conditions can include absence of humidity, such as sealing under vacuum condition in water impermeable packaging. When the mix is radiation curable, the storage conditions can include obstruction of the relevant radiations, such as sealing under black packaging. The period during which a compounded curable mix can be stored in a manner allowing it to remain sufficiently curable for its intended future use may depend on the mix and the storage conditions.

In some embodiments, the ability of the method, according to the present teachings, to enable or maintain desired properties of the nanoparticles being dispersed can be optionally assessed by comparative analysis of the particles before and after dispersion, and when possible, analysis of the primary particles at each point in time. Such analysis can include, for instance, microscopic analysis (e.g., to assess morphology), crystallographic analysis (e.g., to assess crystal structure), and functional analysis. While in some cases the nanoparticles may have properties superior to the crude particles from which they are produced (e.g., a function developing as the size of the particles is reduced), the present method can be deemed satisfactory when the nanoparticles display at least the same properties as the crude particles. For instance, the primary particles of the nanoparticles have a similar morphology, a similar crystal structure, a sought function not less than the crude particles, etc. For illustration, the XRD spectra of the nanoparticles shall be similar to the XRD spectra of the crude particles, at least with respect to the position of the peaks and the planes of orientation of crystal each represent.

Depending on the starting size of the particles to be size-reduced and/or dispersed in the process, as well as on the desired end size of the nanoparticles, the compounding can be performed in a continuous step of sufficient duration or as repeating steps, also termed cycles. Taking for illustration compounding with a three roll mill, the material removed from the apron roll in a first cycle can be fed back between the feed roll and the center roll in a subsequent cycle, and so on, until a desired number of cycles is performed. In some embodiments, wherein the compounding can be performed cyclically, the number of cycles can be at least two, at least three, or at least four. The number of cycles is not particularly limited, especially not for automated processes, but is generally halted once the desired size and distribution of the nanoparticles is obtained.

It is believed that compounding according to the present teachings facilitates inter alia at least one of: a) producing the nanoparticles in a desired size range (e.g., absolute values and/or distribution); b) dispersing the nanoparticles in a viscous medium (the curable melt matrix); and c) prolonging the duration of time the nanoparticles can remain dispersed in the medium (e.g., curable and/or cured). While such achievements, alone or in combination, are beneficial to any type of nanoparticles, they are particularly advantageous for nanoparticles deriving their function and/or potency for the intended use from such parameters (e.g., being well dispersed and within a desired size range and distribution, such dispersion being stable over time).

Taking for comparison methods wherein particles are mixed with a polymer, such mixing being typically performed within a suitable solvent and at a relatively low viscosity, such a medium would favor Brownian motion, which may in turn promote aggregation or separation, that ultimately reduce the ability to produce a stable dispersion in a desired size range. One of the advantages of the present method is its reliance on the relatively high viscosity of the mixture being compounded to effectively transfer the shear force from the equipment or process being used to the particles being dispersed thereby into nanoparticles. In some embodiments, the curable mixture is substantially devoid of a solvent capable of dissolving the pre-polymer (or any other constituent of the mixture). Residual amounts of solvents can be tolerated, as long as compatible with the desired relatively high pre-determined viscosity. If a material, which can be known as a solvent in other systems, is to be included during compounding as presently taught, such “solvent” should be selected to be non-volatile under the compounding conditions desired for the intended melt mixture. A non-volatile liquid typically has a vapor pressure of 40 Pascal (Pa) or less at room temperature, whereas volatile solvents may under similar conditions display vapor pressures of a few kilopascal (kPa), relatively volatile solvents reaching tens or even hundreds of kPas. The volatility of a liquid, or a lack thereof, is to be considered at the temperature of the corresponding step or process, vapor pressure increasing with temperature.

The pre-polymers, regardless of size (e.g., monomers, oligomers, or even short polymers), are cross-linkable, so as to form upon curing larger three-dimensional polymeric networks, having any cross-linking density suitable to the matrix. Typically, the thermoplastic pre-polymers have at least two cross-linkable moieties, and preferably at least three such groups per molecule. Cross-linking can occur via condensation curing, ring-opening, radical curing or addition curing, some chemical families of pre-polymers including more than one type of cross-linkable functions, the curing facilitators and conditions being selected in accordance with the curing route being preferred and enabled by the selection of the pre-polymers. Accordingly, the conditions triggering or favoring curing (e.g., heat, radiation, moisture, etc.) of the curable pre-polymers can be avoided or minimized during compounding of the curable melt mixture. By way of example, the compounding can be performed at a temperature below curing temperature, or in an environment devoid of curing radiation, or in an environment devoid of moisture, or in an environment devoid of any physical and/or chemical factor promoting curing of the pre-polymers being compounded.

If the polymeric matrix containing the dispersed nanoparticles is to be attached to a surface of a device, the pre-polymers can additionally be selected to sufficiently adhere to the intended surface. This is however not essential as the matrix could alternatively be attached to the surface by way of an adhesive or by any suitable mechanical means.

The thermoplastic pre-polymer (or blend thereof) that can be suitable for the present method is preferably solid at room temperature. In some embodiments, the thermoplastic pre-polymer has a glass transition temperature (Tg) of −80° C. or more, −40° C. or more, 0° C. or more, or at least 30° C., at least 50° C., at least 70° C., or at least 90° C. In some embodiments, the thermoplastic pre-polymer has a Tg of at most 260° C., at most 240° C., at most 220° C., at most 200° C., at most 180° C., or at most 160° C. The Tg of pre-polymers, and more generally of semi-crystalline or amorphous materials, is usually provided by their manufacturers. It can be independently determined by standard methods using suitable instrumentation, and for instance can be assessed according to the procedure described in ASTM E1356.

Suitable thermoplastic pre-polymers, can have a softening temperature (Ts) or a melting temperature (Tm) of at least 30° C., at least 50° C., at least 70° C., or at least 90° C. In some embodiments, the thermoplastic pre-polymer has a Ts or a Tm of at most 260° C., at most 240° C., at most 220° C., at most 200° C., at most 180° C., or at most 160° C. The Ts or Tm of pre-polymers is usually provided by their manufacturers. They can be independently determined by standard methods using suitable instrumentation, and for instance Ts can be assessed according to the procedure described in ASTM D1525, whereas Tm can be assessed according to the procedure described in ASTM E794.

In view of the compounding conditions that involve heat, and to the extent the pre-polymers are heat curable at a specific curing temperature, the melting or softening temperatures should be sufficiently lower than the curing temperature to allow compounding to proceed without concurrent curing. In such a case, the pre-polymer should suitably have a melting and/or a softening temperature at least 30 C° lower than the curing temperature, at least 40 C° lower, or at least 50 C° lower.

A suitable thermoplastic pre-polymer (or blend thereof) can additionally have a relatively low melt flow index (MFI), sufficiently low to facilitate the shearing of the curable melt mixture. The melt flow index, also called melt flow rate (MFR), is an inverse measure of viscosity based on a rather crude test involving the extrusion of a polymer through a die of standard dimensions under the action of a prescribed weight at a predetermined temperature. The MFI is the number of grams of polymer collected from the test apparatus in 10 min. Low MFI values mean high viscosity and high molecular weight, and in some embodiments the curable thermoplastic pre-polymer has a MFI between 0.01 and 10, as measured in the temperature range from 145° C. to 175° C., at a low loading of 2.16 kg. MFI or MFR can be assessed according to the procedure described in ASTM D1238.

As appreciated by a skilled person, while the above-guidance was provided with respect to the pre-polymer, the necessary information being more readily available for isolated materials, similar principles apply to the curable mixture, or to relevant constituents thereof. For illustration, a curing agent may be solid at room temperature, hence may have a Tm or a Ts of at least 30° C., etc. This is not however essential, and a curing facilitator may be liquid at room temperature as long as its relative presence in the curable melt, in particular with respect to the pre-polymer, is such that the mixture can satisfy the recommendations as set forth for the selection of a suitable material. Typically, curing facilitators are added in an amount that is in excess of stoichiometrically required to ideally cross-link each of the cross-linkable moieties of the curable pre-polymer. For instance, curing agents can be added to the curable melt at a weight ratio between 0.1:1 and 1:1 by weight of the curable thermoplastic pre-polymer, whereas curing accelerators can be added at a weight ratio between 0.01:1 and 0.1:1 by weight of the curable thermoplastic pre-polymer. As for dispersants or any other additives present in the melt mixture, curing facilitators should be in an amount ensuring that the characterizing temperature of the mixture does not drop below one of a Ts or Tm being lower than 30° C., as this may reduce the efficacy of the compounding step (i.e., the viscosity being too low for transfer of significant enough shearing).

The softening, melting, glass transition and curing temperatures of pre-polymers, or any other materials to which these parameters apply, are typically provided by their manufacturers, but can be independently determined by routine experimentation. Suitable methods include thermomechanical analysis (TMA), thermogravimetric analysis (TGA), differential scanning calorimetry (DSC), dynamic mechanical analysis (DMA), Vicat method, Heat Deflection Test, and a ring and ball method, which are known to the skilled persons. Such characterizing temperatures are typically established at standard pressure of 1 atmosphere, but one can readily appreciate that a change in the properties of the substance reflected by these temperatures can alternatively take place at a lower temperature or a higher temperature, if the pressure in a sealed chamber hosting the process were to be accordingly reduced or increased. Therefore, while in the description of a method suitable for the preparation of a composition according to the present teachings, reference can be made to specific temperatures and duration of times assuming the process is carried out under standard pressure, such guidance should not be viewed as limiting and all temperatures and durations achieving a similar outcome with respect to the behavior of the compounded materials are encompassed.

Curable thermoplastic pre-polymers can be selected from a wide range of polymer families both synthetic and naturally-occurring. Natural thermoplastic pre-polymer can be shellac or rosins. Synthetic thermoplastic pre-polymer can be selected from a group comprising acrylic resins, epoxy resins, phenol resins, phenoxy resins, polyurethane resins, silicone resins, co-polymers thereof, and combinations thereof.

In some embodiments, suitable pre-polymers can have an average molecular weight (MW) adapted for the pre-polymer to be solid at least at room temperature and optionally up to 10 C° less than a temperature suitable for its compounding.

If the pre-polymers are epoxy resins, they can be selected by the number of epoxy groups per monomer, and suitable epoxy resins can have 3 epoxy groups or more, 4 epoxy groups or more, the suitable number of epoxy groups per monomer of such pre-polymers typically not exceeding 9, being in some embodiments no more than 8, or no more than 7. Another parameter that can be used for the selection of epoxy resins is the epoxy equivalent weight (EEW), which is defined as the weight of resin in grams that contains one equivalent of epoxy. As the resin's molecular weight increases, the EEW will also increase. In some embodiments, epoxy resins being suitable pre-polymers can have an EEW in the range of 500 to 3,000.

The thermoplastic pre-polymers can be selected in accordance with the intended use of the composite of cured polymer and nanoparticles. By way of example, the polymer can be electrically, thermally or optically insulating, or conversely conducting, if so desired.

The curing agents and curing accelerators that may be used in the composition are selected in accordance with the chemistry of the thermoplastic pre-polymers and the compounding conditions. They can each be added in a relative amount as necessary to achieve a desired cross-linking density and/or a desired rate of curing. The curing facilitators, when present, should preferably not significantly decrease the viscosity of the curable melt mixture to an extent impairing the effect of shear force on the mixture.

Advantageously, but not necessarily, a thermoplastic curable pre-polymer may include in its molecular structure a moiety having some affinity to the nanoparticles to be dispersed therein. For example, the affinic moiety can be a hydroxyl group, a carboxyl group, an amine group, or an acrylate, as may be adapted to bind to the surface of the nanoparticles. In absence or insufficiency of such groups, a dispersant may be added to the mixture. It is to be noted that the interactions afforded between the pre-polymers and the nanoparticles, optionally via the dispersants, do not necessarily require covalent binding.

Notably, while conventional dispersions of nanoparticles typically require a substantial amount of dispersant, which may be of more than 2:1 by weight of the particles, the present method allows using significantly lower amounts of dispersant, if at all. In some embodiments, a dispersant (or a blend thereof) can be present at a weight ratio by weight of particles of 1:3 or less, 1:5 or less, 1:10 or less, 1:15 or less, 1:20 or less, 1:25 or less, or 1:30 or less. In case that a dispersant is added and that such a dispersant affects the characterizing temperatures of the melt mixture, care should be taken that a softening temperature or a melting temperature of the mixture remains above 30° C. for the compounding to stay effective.

As above exemplified for the thermoplastic curable pre-polymer and the particles to be dispersed therein, the materials used for the compositions of the present method are preferably compatible, not only for their individual role, but also one with the other. Fundamentally, a material or a chemical composition is compatible with another if it does not prevent its activity or does not reduce it to an extent that would significantly affect the intended purpose. Materials should also be compatible with the methods used for the preparation of the composition. By way of non-limiting example, materials compatible for compounding should substantially form a single phase (e.g., a slurry) and not separate in a manner adversely affecting a uniform mixing of all components. They should also be resistant to the temperatures, pressures, shear forces and any such operational parameter applied during any single step of the method, so as to avoid thermal or physical degradation impairing their intended respective role and/or their mutual interactions. Materials can be, individually or jointly, physically and/or chemically “compatible”. As readily understood, this principle of compatibility, which can be affected not only by the chemical identity of the materials, but by their relative proportions according to the intended use, should preferably guide the selection of all materials necessary for the compositions and methods disclosed herein.

Advantageously, the present method allows a relatively high loading of particles (hence of nanoparticles) in the curable melt mixture. Understandingly, the extent of loading may depend on the desired size distribution of the nanoparticles, smaller nanoparticles having a relatively higher surface area per weight. It should be noted that the smaller the nanoparticles, the higher the viscosity of the curable mixture. Moreover, while the following ratios are provided by weight, clearly the density of the materials being dispersed one in the other may affect the ranges of loading feasibility. For illustration, the weight per weight ratio of particles to curable thermoplastic pre-polymer can be of up to 10:1, or up to 5:1, or up to 2:1, the loading being selected according to the intended use.

The present disclosure is concerned, inter alia, with the dispersion of particles. The dimension of particles in X-Y-Z directions can be individually assessed, however are typically provided for a population of particles. The population can be found in a representative field of view, when the dimensions are measured by microscopy, or in a representative suspension of the particles, when the dimensions are measured by Diffractive Light Scattering (DLS) or Light Scattering (LS), the former being more suited for relatively smaller particles (e.g., of up to 6 μm) and the latter being more suited for relatively larger particles (e.g., of up to 3.5 mm).

The dimensions most suitably characterizing a particle may depend on its shape and would, for instance, be a diameter, if the particles are globular or spherical, a thickness, if the particles are platelets or flake-like, or a width or length, for a planar dimension of a flake or for a rod-like particle.

The particles may therefore be alternatively or additionally characterized by an aspect ratio, i.e., a dimensionless ratio between the smallest dimension of the particle and the longest dimension or equivalent diameter in the largest plane orthogonal to the smallest dimension, as relevant to their shape. The equivalent diameter (Deq) is defined by the arithmetical average between the longest and shortest dimensions of that largest orthogonal plane. Particles having an almost spherical shape are characterized by an aspect ratio of approximately 1:1, whereas rod-like/needle-like particles can have higher aspect ratios (e.g., up to 1:10 or to 1:20) and flake-like particles can even have an aspect ratio of at least 1:100.

Such characteristic dimensions can be provided by the suppliers of such particles and can be assessed on a number of representative particles by methods known in the art, such as microscopy, including, in particular, by light microscope for particles of several microns or down to estimated dimensions of about 200 nm, by scanning electron microscope SEM for smaller particles having dimensions of less than 200 nm (SEM being in particular suitable for the planar dimensions) and/or by focused ion beam FIB (preferably for the thickness of nanoparticles). While selecting a representative particle, or a group of representative particles, that may accurately characterize the population (e.g., by diameter, longest dimension, thickness, aspect ratio and like characterizing measures of the particles) can be within the skills of a trained operator, it will be appreciated that a more statistical approach may be desired and yet more accurately characterize such characterizing dimension of the particles.

When using microscopy for particle size characterization, a field of view of the image-capturing instrument (e.g., light microscope, SEM, FIB-SEM etc.) is analysed in its entirety. Typically, the magnification is adjusted such that at least 5 particles, at least 10 particles, at least 20 particles, or at least 50 particles are disposed within a single field of view. Naturally, the field of view should be a representative field of view as assessed by one skilled in the art of microscopic analysis. The average value characterizing such a group of particles in such a field of view can be obtained by volume averaging. In such case, D_{V}50=Σ[(Deq(m))³/m]^{1/3}, wherein m represents the number of particles in the field of view and the summation is performed over all m particles. As mentioned, when such methods are the technique of choice for the scale of the particles to be studied or in view of their media, such measurements can be referred to as D50.

Generally, D10, D50 and D90, which represent the size distribution of the particles for 10%, 50% or 90% of the population can be assessed by number of particles in the population, in which case they may be provided as D_{N}10, D_{N}50 and D_{N}90, or by volume of particles, in which case they may be provided as D_{V}10, D_{V}50 and D_{V}90. A high similarity between the values that may be determined by number or by volume is indicative of a relatively high uniformity of the population. “High similarity” is found if at a given proportion of the population, the lowest value is smaller than the highest value by 20% of the highest value or less, preferably by less than 15%, or by less than 10%. For illustration, if a population of nanoparticles has a D_{V}90 of about 100 nm, then if the population has a D_{N}90 in the range of 80-100 nm, 85-100 nm, or 90-100 nm, then the values have high similarity and the population has a relatively high uniformity, such findings being preferably observed at additional points along the size distribution (e.g., at D10 and D50). While the present teachings advantageously provide for a high similarity between the values that may be determined by number or by volume with respect to the size of the dispersed nanoparticles and their size distribution, if one method is to be singled out to unambiguously clarify this matter and the results being enabled, size of nanoparticles and distribution thereof shall be determined by number.

The foregoing measurements can be obtained by DLS or LS techniques when the samples to be studied are suitably fluid (e.g., dilute), the particles being approximated to spheres of equivalent behavior and the characteristic dimension retrieved by such methods being termed the “hydrodynamic diameter” of the particles. However, when the particles under study are in viscous media or in cured matrices, then typically such measurements are performed by microscopy. As used herein, D50, which can also be termed the “average particle size” may refer, depending on the measuring method most suited to the particles being considered and their media, either to the number or volume average size of particles found in a field of view of a microscope adapted to analyse in the scale of the particles, or to D_{N}50 or D_{V}50 as measured by DLS, LS and like techniques. Such measurements can additionally relate to primary particle size or to secondary particle size, as applicable, a population of particles, generally including both types, primary particles predominating in well dispersed populations and secondary particles predominating in “raw” particles, prior to size-reduction or dispersion.

In some embodiments, the nanoparticles produced by the method have an average particle size (D_{V}50 or D_{N}50) of at most 100 nm, at most 75 nm, or at most 50 nm.

In some embodiments, the nanoparticles produced by the method have an average particle size (D_{V}50 or D_{N}50) of at least 20 nm, at least 25 nm, at least 30 nm, or at least 35 nm.

In some embodiments, the nanoparticles produced by the method have an average particle size (D_{V}50 or D_{N}50) between 20 nm and 100 nm, between 20 nm and 75 nm, between 20 nm and 50 nm, between 25 nm and 100 nm, between 30 nm and 80 nm, between 30 nm and 50 nm or between 35 nm and 60 nm.

In some embodiments, the nanoparticles produced by the method have a minimal particle size (D_{V}1 or D_{N}1) of at least 5 nm, at least 10 nm, or at least 15 nm.

In some embodiments, the nanoparticles produced by the method have a maximal particle size (D_{V}99 or D_{N}99) of at most 200 nm, at most 180 nm, or at most 160 nm.

In some embodiments, the nanoparticles produced by the method have a particle size substantially entirely (e.g., from D0.1 to D99.9, or from D1 to D99) distributed between 20 nm and 200 nm, between 25 nm and 180 nm, or between 30 nm and 160 nm. In particular embodiments, the size distribution of the nanoparticles is closely related to the size of the primary particles, suggesting that the nanoparticles are individual primary particles or small clusters thereof. The size distributions are deemed “closely related” if, for instance, the maximal particle size of the nanoparticles exceeds the maximal primary particle size by 100% of the maximal primary particle size or less, or by less than 80%, less than 60% or less than 40%. For illustration, if the maximal size of an individual primary particle is 100 nm, then the maximal particle size (D_{V}99 or D_{N}99) of the nanoparticles shall be no more than 200 nm (100 nm+(100%×100 nm)), no more than 180 nm, no more than 160 nm, or no more than 140 nm. In other words, if primary particles have a size distributed between 30 nm and 100 nm, then nanoparticles may have their size distributed between 30 nm and 200 nm.

For particular applications, it may be desired that the nanoparticles have a narrow distribution of size, between the smallest and largest particle of the population. While, ideally, such assessments can be made for a 100% of the population of particles (from D_{V}0 to D_{V}100, or from D_{N}0 to D_{N}100, but typically depending on instrumentation and sensitivity of detection for at most 99.8% of the population from D_{V}0.1 to D_{V}99.9, or from D_{N}0.1 to D_{N}99.9), the distribution may also be estimated on a smaller portion of the population and can, for instance, be made for 98% of the population (from D_{V}1 to D_{V}99, or from D_{N}1 to D_{N}99), for 90% of the population (from D_{V}5 to D_{V}95, or from D_{N}5 to D_{N}95), or even for 80% of the population (from D_{V}10 to D_{V}90, or from D_{N}10 to D_{N}90).

A particle size distribution is said to be relatively narrow if at least one of the following conditions applies:
A) the difference between the hydrodynamic diameter of 90% of the particles and the hydrodynamic diameter of 10% of the particles as can be set by number or by volume is equal to or less than 180 nm, equal to or less than 150 nm, or equal to or less than 100 nm, or equal to or less than 50 nm, which can be mathematically expressed by: (D90−D10)≤180 nm and so on;
B) the ratio between a) the difference between the hydrodynamic diameter of 90% of the particles and the hydrodynamic diameter of 10% of the particles; and b) the hydrodynamic diameter of 50% of the particles, is no more than 2.0, or no more than 1.5, or no more than 1.0, which can be mathematically expressed by: (D90−D10)/D50≤2.0 and so on; and
C) the polydispersity index of the particles is equal to or less than 0.4, equal to or less than 0.3, equal to or less than 0.2, or equal to or less than of 0.15, which can be mathematically expressed by: PDI=σ²/d²≤0.4 and so on, wherein σ is the standard deviation of the particles distribution and d is the mean size of the particles, the PDI optionally being equal to 0.01 or more, 0.05 or more, or 0.1 or more.

In some embodiment, the nanoparticles produced by the present method not only have a narrow size distribution as aforesaid, but moreover form a unimodal/monodisperse population. The nanoparticles are deemed “monodisperse” if their PDI is less than 0.1.

In some embodiments, the method further comprises: a—depositing the curable melt mixture on a suitable surface or within a suitable volume; and b—curing the deposited mixture, the curing being performed under conditions (e.g., temperature, relative humidity, time duration) selected and adapted to the curable polymer, the curing agent and the curing accelerator, if present, and to the dimensions of the deposited mixture.

While the method herein disclosed is typically performed at an ambient pressure of about 100 kPa, alternatively at least a step thereof may be carried out at an elevated pressure (e.g., at 125 kPa or more, 150 kPa or more, 175 kPa or more, 200 kPa or more, 250 kPa or more, or 300 kPa or more) such increased pressure typically facilitating and/or accelerating the step and/or the process.

In a further aspect, the disclosure provides a process for dispersing nanoparticles of afunctional material in a curable polymer, the process comprising:
a) providing particles of the functional material;
b) providing a curable thermoplastic pre-polymer;
c) optionally providing a dispersant selected and adapted to disperse the particles in the curable pre-polymer;
d) compounding the curable pre-polymer, the functional particles and the optional dispersant at a temperature sufficiently high to obtain a melt mixture and sufficiently low for the melt mixture to develop a desirable pre-determined viscosity upon compounding;
   wherein the compounding is performed by applying substantially only a shear force to the melt mixture, the shear force being such that the particles are reduced to nanoparticles and the viscosity being such that the nanoparticles formed by the applied shear force are dispersed in the mixture.

In a further aspect of the present disclosure, there is provided a cured polymeric matrix containing stably dispersed nanoparticles, the matrix being prepared according to the teachings herein.

In another further aspect of the present disclosure, there is provided a device or a composition of matter including an element made of a cured polymeric matrix containing stably dispersed nanoparticles, the matrix being prepared according to the teachings herein.

For illustration, if the nanoparticles function as radiation absorbers, cut-off or band path filters, a cured polymeric matrix containing the same can be incorporated in devices, such as lenses or radiation filters, and can be incorporated in composition of matters, such as UV-blockers. The nanoparticles can be made of any desired functional material adapted to provide to the cured polymeric matrix including said nanoparticles the sought properties. Materials that may as nanoparticles impart, for illustration, desired mechanical, thermal, electrical, optical, detecting or magnetic properties are known, and some are listed herein. The “function” of the nanoparticles can also be purely esthetical.

Before explaining at least one embodiment in detail, it is to be understood that the disclosure is not necessarily limited in its application to the details of construction and the arrangement of the components and/or methods set forth herein. The disclosure is capable of other embodiments or of being practiced or carried out in various ways. The phraseology and terminology employed herein are for descriptive purpose and should not be regarded as limiting. Upon perusal of the description and figures present herein, one skilled in the art is able to implement the disclosure without undue effort or experimentation. Well known methods, procedures, formulations or components have not been described in details, so as not to obscure the present invention.

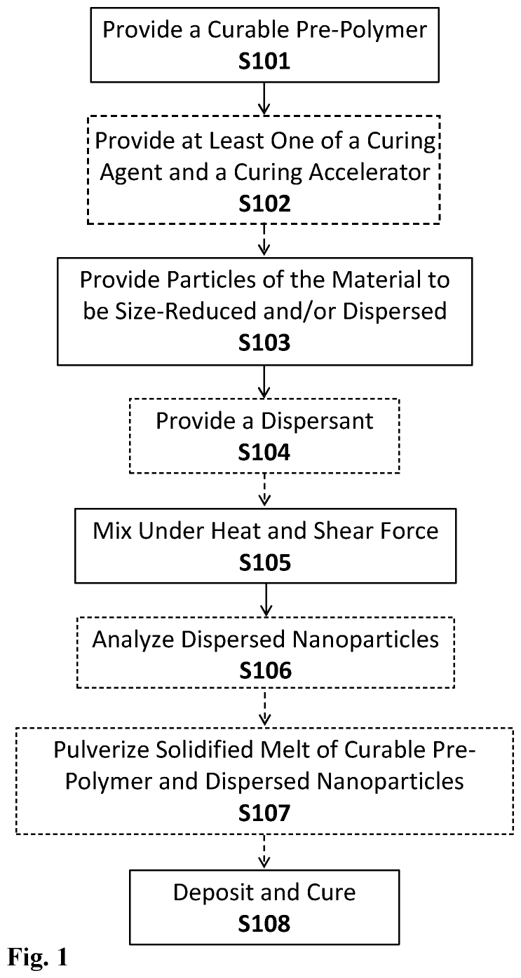

Referring to FIG. 1, it schematically depicts a method of dispersing nanoparticles in a curable polymer matrix according to the present teachings, dashed lines and frames relating to optional steps. In a first step S101, there is provided a curable thermoplastic pre-polymer as set forth herein. In an optional second step S102, curing facilitators (e.g., cross-linkers, hardeners, catalysts, etc.) adapted to the curable pre-polymers may be supplied. The particles can be added to the pre-polymers (with or without curing facilitators) either “as is”, as illustrated in step S103, or with a dispersant further included in optional step S104. As readily appreciated, these steps can be performed in any suitable order, as long as a desired mixture of constituents is made available to the compounding step S105, in which the mixture is subject to heat, so as to obtain the melt curable mix, and to shear forces, so as to size reduce and disperse the particles into nanoparticles. While the optional addition of curing facilitators S102 is illustrated in this figure as taking place prior to compounding so that such agents are present during the compounding step S105, this is not the sole possibility. Alternatively, the curing facilitators, if present, can be added after compounding, for instance prior to optionally pulverizing (S107) or prior to curing (S108). The curable melt mix can optionally be sampled in step S106, to analyse the size and the distribution of nanoparticles produced by the time of sampling. This step may be omitted, and the curable mix deposited (e.g., cast, injected, molded, pressed, etc.) on any desired substrate and cured in step S108 by a curing method adapted to the curable pre-polymers (and curing facilitators, if present). As readily appreciated, the curable mixture obtained in step S105 can optionally be pulverized to a powder at a temperature below its Tg or Tm (S107) prior to being stored for future use (not shown) or being deposited on a desired support for subsequent curing in step S108, which need not be performed in immediate time continuity with the compounding. As readily appreciated by a person skilled in the preparation of powders, the pulverization is best effected when the material is friable, hence such step being performed below the glass transition temperature for both amorphous and crystalline materials. For relatively more crystalline materials also having a Tm, pulverization might additionally be performed at a temperature below the melting point. Advantageously, in some embodiments, the compounding step S105, and steps relating thereto, and the curing step S108, and steps relating thereto, can be performed at different times, at different premises, and/or by different entities.

### EXAMPLES

Aspects of the present teachings herein were experimentally demonstrated, as disclosed in the following examples.

### Example 1: Preparation of a Curable Melt Mix

### Example 1A-Dispersion of Nanoparticles Having Magnetic Properties

A powder of a ferrous alloy having magnetic properties, namely iron-cobalt (Fe—Co) having a density of about 8.17 g/cm³, was weighted in a glove box under an inert atmosphere of argon and transferred to a glass container containing at least a same weight amount of volatile solvent (e.g., acetone having a vapor pressure of about 30 kPa at room temperature) in which a suitable phosphoric acid ester dispersant (e.g., polyoxyalkylene alkyl ether phosphoric acid ester having a HLB of 9, such as commercialized by DKS under trade name Plysurf A208F) was previously dissolved in a weight amount corresponding to 5 parts of dispersant per 100 parts of particles. The amount of solvent used in this step is not critical, as this material is to be evaporated. However, to facilitate the evaporation step, the volatile solvent is typically no more than twice the weight of the constituents to be dissolved therein.

Following sufficient wetting and mixing of the particles with the dispersant in the volatile solvent, the pre-mix was taken out of the glove box, and subsequent mixing for five more minutes was performed in a ventilated chemical hood. Mixing was performed by placing the glass container on an orbital shaker (Heidolph Unimax 1010) set to vigorously agitate the liquid to efficiently blend the ingredients. A curable pre-polymer consisting of a cresol novolac based epoxy resin having an epoxy equivalency of 209-219 g/eq, a softening temperature of about 90-100° C., and a melt viscosity of about 2.4-3.4 Pa·s (e.g., such as commercialized by DIC Corporation under trade name Epiclon® N-695), was weighted and mixed with a suitable curing agent, such as a homopolymer of p-hydroxystyrene (CAS No. 24979-70-2, such as commercially available as Maruka Lyncur M S-2P) having a weight average molecular weight of approximately 4-6,000 g/mol. The curing agent was added to the epoxy resin in a weight amount of about 56 wt. % of the weight of the resin, and both were placed in a glass vessel containing about twice their combined weight of volatile solvent. The resin and its curing agent were dissolved in the solvent at room temperature under constant shaking for about 30 minutes. The particles and their dispersant were then added and further jointly mixed until a homogenous slurry was obtained. The slurry contained, except for the solvent being ignored, 81.4 wt. % of magnetic particles, 4.1 wt. % of dispersant, 9.3 wt. % of pre-polymer, and 5.2 wt. % of curing agent, by total weight of a dry composition. The epoxy pre-polymers used in the instant example illustrate pre-polymers which can be cured by radical polymerization and epoxy reaction.

The volatile solvent was evaporated by drying the slurry in a ventilated oven for 5 hours at 55° C., following which most of the solvent evaporated and the slurry displayed the consistency of wet mud. The vessel was then placed into a vacuum oven for 12 hours at room temperature, till the mix was substantially dried.

The dry mixture of the curable constituent was gradually fed to the nip of a two roll mill (Plasti-Corder® by Brabender), the rolls being pre-heated to have a surface temperature of about 90° C. The melt paste formed at a first cycle of passage between the two heated rolls being rotated at a speed of 35 rpm (rounds per minute) was recycled and fed again, and this was repeated for a total time of about five minutes, at which time the curable melt mix had a homogeneous appearance. The curable melt mix containing dispersed nanoparticles of the ferrous alloy having magnetic properties was placed in a sealable container and allowed to cool to room temperature until further study.

The heating temperature of the curable mix during the compounding step can be determined based on information available on the constituents of the mix, as detailed herein-above, or can be experimentally estimated by testing the viscosity of the dry mix as temperature is increased and a melt mix is forming. The temperature selected for compounding corresponds approximately to the temperature at which the mixture turns sufficiently molten (displaying a relatively sudden drop in the viscosity of the mix).

The above-procedure was performed a few more times with the same or different relative proportions between the afore-mentioned constituents of the curable mix to obtain a number of samples containing dispersed nanoparticles of Fe—Co.

The viscosity of the curable melt mixture near the temperature of compounding can be assessed using a rheometer (Thermo Scientific HAAKE MARS), with a spindle PP20E 20 mm, at a shear rate of 10 Pa sec⁻¹ and a frequency of 1 Hz. The viscosity of the sole pre-polymer, Epiclon® N-695, was measured by this procedure and found to be in a range from about 10 to 40 kPa·s at temperatures between about 80° C. and 95° C.

### Example 1B-Dispersion of Nanoparticles Having Radiation Absorbing Properties

The procedure previously described with respect to Example 1A was used to disperse particles made of additional materials and with different properties in other types of curable-pre-polymers. In the present example, the particles being dispersed were made of titanium dioxide (TiO₂, commercially available as MT-700Z from Tayca Corporation) having a density of about 4.23 g/cm³, this metal oxide having absorbing properties in the UV-range if properly dispersed to have a particle size in the nanometric range. These particles were compounded in absence of a dispersant in a copolyester pre-polymer with primary hydroxyl functionality (commercially available as Dynacoll®7150 from Evonik) in presence of 4,4-methylene-bis(phenyl isocyanate) as curing facilitator. The polyol pre-polymers used in the instant example illustrate pre-polymers which can be cured by condensation polymerization.

The dry composition fed to the two roll mill contained 20 wt. % of radiation absorbing particles, 76.5 wt. % of pre-polymer, and 3.5 wt. % of curing agent, by total weight. The compounding was performed at a surface temperature of the rolls of about 110° C. The melt paste formed at a first cycle of passage between the two heated rolls being rotated at a speed of 35 rpm was recycled and fed again, and this was repeated for a total time of about ten minutes, at which time the curable melt mix had a homogeneous appearance. The curable melt mix containing dispersed nanoparticles of the metal oxide having radiation absorbing properties was placed in a sealable container and allowed to cool to room temperature until further study.

The viscosity of the sole curable pre-polymer, Dynacoll®7150, near the temperature of compounding was assessed as previously described and found to be in a range from about 0.1 kPa·s to 0.5 kPa·s, at temperatures between about 90° C. and 110° C.

### Example 1C-Dispersion of Fine Nanoparticles Having Thermo-Conductive Properties

The procedure previously described with respect to Example 1A was used to disperse particles made of additional materials and with different properties in other types of curable-pre-polymers. In the present example, the particles being dispersed were made of diamond (commercially available as uDiamond® Molto by Carbodeon) having a density of about 3.51 g/cm³, this ceramic material having thermal conductivity properties. These particles, having a primary particle size in the very low nano range of about 4-6 nm, were compounded in absence of a dispersant in a UV-curable amorphous unsaturated polyester acrylate pre-polymer (commercially available as Uvecoat®3003 by Allnex). A difunctional alpha-hydroxy ketone (commercially available as Esacure KIP 160 by IGM Resins) was used as photo-initiator (i.e. curing facilitator) for these pre-polymers. The UV-curable pre-polymers used in the instant example illustrate pre-polymers which can be cured by radiation in the UV range.

The dry composition fed to the two roll mill contained 5 wt. % of thermo-conductive particles, and 93 wt. % of pre-polymer, and 2 wt. % of curing agent, by total weight. The compounding was performed at a surface temperature of the rolls of about 110° C. The melt paste formed at a first cycle of passage between the two heated rolls being rotated at a speed of 35 rpm was recycled and fed again, and this was repeated for a total time of about ten minutes, at which time the curable melt mix had a homogeneous appearance. The curable melt mix containing dispersed nanoparticles of the ceramic having thermo-conductive properties was placed in a sealable container and allowed to cool to room temperature until further study.

The viscosity of the sole curable pre-polymer, Uvecoat® 3003, near the temperature of compounding was assessed as previously described and found to be in a range from about 1 kPa·s to 10 kPa·s, at temperatures between about 90° C. and 110° C.

### Example 1D-Dispersion of Nanoparticles Having Mechanical Reinforcing Properties

The procedure previously described with respect to Example 1A was modified and used to disperse particles made of additional materials having different properties. The modifications mainly related to the timing of the addition of the curing agent during the preparatory process. For reference, in Example 1A the curing agent was blended with the curable pre-polymer before being mixed with the particles of ferrous alloy and their dispersant to form the homogenous slurry.

In the present example, the particles being dispersed were monodisperse spherical silica nanoparticles (such as commercially available as Idisil® VPS KE 80 P by Evonik Resource Efficiency GmbH) having a density of about 2.65 g/cm³ and an average particle size D50 of 73 nm in a narrow size distribution with a D10 of about 62 nm and a D90 of about 82 nm, this ceramic material being inter alia capable of improving the mechanical properties of materials (e.g., polymers) compounded therewith. These particles were compounded with the same curable pre-polymer and curing agent as described in Example 1A, namely with a curable epoxy resin (Epiclon® N-695) and with a homopolymer of p-hydroxystyrene (CAS No. 24979-70-2) as curing agent. The dispersant was a combination of mono-n-octyl-, di-n-octyl-, mono-n-decyl-di-n-decyl phosphoric acid ester (such as commercially available as ILCO PHOS 204 by ILCO Chemikalien GmbH), and the relative concentrations of the ingredients at the end of the compounding and dispersing process was of 41.7 wt. % of silica, 7.2 wt. % of dispersant, 32.7 wt. % of pre-polymer, and 18.3 wt. % of curing agent, by total weight of a dry composition, regardless of the steps at which the afore-said ingredients were added and mixed one with the other(s). As the nanoparticles of silica are more stable than ferrous alloys, all mixing steps were performed under ambient air atmosphere and procedures previously executed under inert gas in a glove box were performed in a standard ventilated chemical hood.

The silica nanoparticles were pre-mixed with the dispersant in twice their combined solid weight of acetone, the mixing being vigorously performed for about 5 minutes at room temperature using an orbital shaker. The pre-polymer resin was separately dissolved in twice its weight of acetone solvent at room temperature under constant shaking for about 30 minutes. The particles and their dispersant were then added to the dissolved curable pre-polymer and all were further jointly mixed until a homogenous slurry was obtained. The slurry lacking a curing agent was dried in a ventilated oven for 5 hours at 55° C., following which most of the solvent evaporated and the slurry displayed the consistency of wet mud. The vessel was then placed into a vacuum oven for 12 hours at room temperature, till the mix was substantially dried.

In a first modified method, the curing agent was added during the compounding of the dry mixture in the two roll mill, the rolls being pre-heated to have a surface temperature of about 90° C. The dry mixture was first allowed to form a uniform melt paste (by refeeding the mixture to the nip of the two roll mill for about five minutes), at which time the curing agent was added as solid material to the paste and mixed therewith by recirculating the paste through the nip for about one more minute until a curable melt mix of homogeneous appearance was obtained.

In a second modified method, the curing agent was added after the compounding of the dry mixture in the two roll mill. The homogeneous curable melt mix obtained in the process was dissolved together with a suitable amount of the curing agent in twice their combined weight of volatile solvent. They were vigorously mixed for about 30 minutes at room temperature until a homogenous slurry was obtained. The curable mixture now including the curing agent was first dried in a ventilated oven for 5 hours at 55° C. to eliminate most of the solvent, and the resulting wet mud was placed into a vacuum oven for 12 hours at room temperature, till the curable mix was substantially dried.

In a third modified method, the curing agent was added with the pre-polymer of the epoxy resin as done in Example 1A, however the silica nanoparticles were not previously separately dispersed and all ingredients were weighted and jointly mixed in excess volatile solvent for about 40 minutes at room temperature. The obtained slurry was processed as previously described being dried in a ventilated oven for 5 hours at 55° C. to evaporate most of the solvent, the resulting wet mud being substantially dried in a vacuum oven for 12 hours at room temperature. The dried mix was compounded as described in Example 1A.

### Example 2: Size Characterization of Dispersed Nanoparticles

The particles used in Example 1A were added to the mix while having a starting particle size distribution corresponding to relatively large aggregates, the particles having an average secondary particle size of about 80 to 600 nm, as compared to a stated primary particle size of about 45 nm. To assess the efficacy of the present method to produce nanoparticles, their size was determined ahead of curing.

A sample of the melt mix containing a pre-determined amount of particles (e.g., 1 g for a test composition containing 1 wt. % of particles) was weighted and placed in a glass vessel. A solvent adapted to eliminate (e.g., dissolve) the polymer was added in excess, together with a dispersing agent, the solvent and dispersing agent not being necessarily those used for the preparation of the curable melt mix, but being adapted to maintain the nanoparticles in dispersed form in a liquid. The solvent and dispersing agent constitute jointly 99 wt. % of the test composition. Zinc stearate was used as dispersing agent, at a weight amount of 1.3:1 per calculated weight of particles, the solvent being cardanol (such as commercialized by Cardolite under trade name NX-2026). 20 ml of the test composition was placed in a 110 ml stainless steel cup of an attritor mill (Union Process HD01 Atritor mill) together with 60 ml of stainless steel beads having a diameter of about 2 mm. Mixing was allowed to proceed at a controlled temperature of 25° C., at a speed of 700 rpm for about 9 hours, at which time the nanoparticles were believed to be sufficiently extracted from the polymer envelop of the melt mix. It should be emphasized that the gentle mixing conditions used for the present extraction are devoid of impact forces and unable to further reduce the size of nanoparticles as obtained by the method of Example 1.

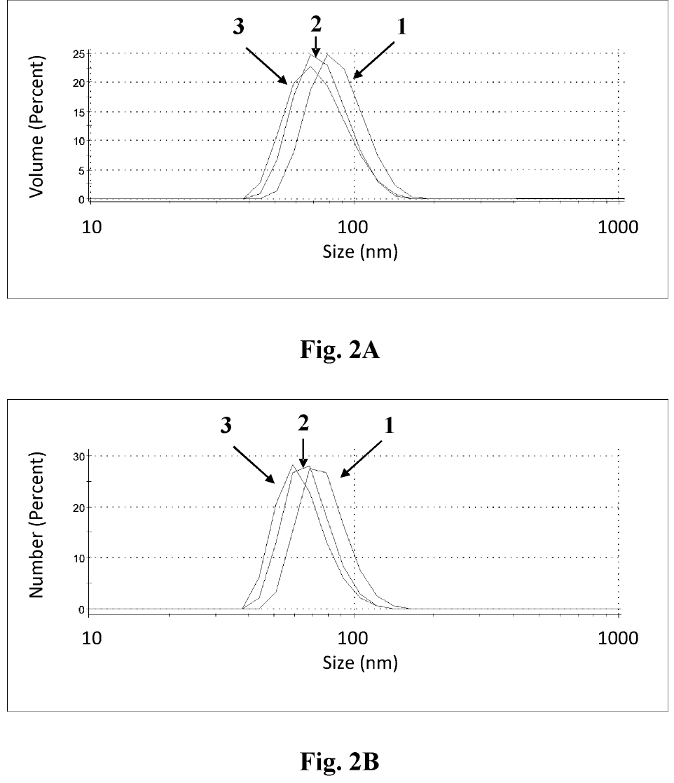

The milled test composition was further diluted in the test solvent (e.g., cardanol) to prepare a diluted sample of up to 0.1 wt. % nanoparticles, having an optical density suitable for the range of detection of the DLS. The sample was vigorously mixed by vortex, then sonicated for seven seconds at 75% amplitude in an ultrasonic processor (Vibra-Cell™ VCW 750, by Sonics & Materials) prior to the size of the nanoparticles being determined by DLS (Malvern Zetasizer NanoS). The size distribution of the particles was assessed by number of particles or by volume of particles, FIG. 2A showing representative curves of size distribution of nanoparticles by number and FIG. 2B by volume. Three curves numbered 1 to 3 are shown in these figures, each corresponding to a similar curable mix prepared according to Example 1A, the resulting nanoparticles of which were extracted as detailed above.

The particle sizes of these three samples (in nanometers) are provided in the following table for 10%, 50% and 90% of the population, both by volume and by number. The polydispersity index (PDI) calculated by the instrument is also presented.

TABLE 1

| Sample | | | | | | | |
|---|---|---|---|---|---|---|---|
| No. | D_{V}10 | D_{V}50 | D_{V}90 | D_{N}10 | D_{N}50 | D_{N}90 | PDI |
| 1 | 62.0 | 83.8 | 117.0 | 57.8 | 75.0 | 102.0 | 0.089 |
| 2 | 54.6 | 73.7 | 102.0 | 51.3 | 66.1 | 89.3 | 0.024 |
| 3 | 51.7 | 70.7 | 102.0 | 47.4 | 62.1 | 86.2 | 0.023 |
| Comp. | 50.0 | 83.2 | 203.0 | 42.1 | 56.8 | 87.7 | 0.166 |

As can be seen both from the figures and the particle sizes determined by DLS presented in Table 1, the values obtained by number of particles and by volume of particles are relatively similar for nanoparticles prepared according to the present teachings. Importantly, the PDI values of all three samples are particularly low (all below 0.1) and indicative of a mono-disperse distribution.

Noticeably, the particle size distributions displayed by the nanoparticles obtained in the three samples prepared according to Example 1A were achieved by application of shear force during a brief period of up to 5 minutes. For comparison, the results obtained with a comparative sample, prepared by wet milling for 12 hours as described in the following example, are also presented in the last row of Table 1. While the D10, D50 and D90 values obtained by number seem similar to those obtained by the present method, the values obtained in the comparative sample by volume shows that the conventional process is not only less time-efficient, but also less effective with respect to the population of particles actually size-reduced and/or dispersed. On average all three samples 1-3 have a D_{V}90 of 107 nm as opposed to a D_{N}90 of 92.5 nm, in other words the D_{V}90 of the three samples is about 116% of their D_{N}90 meaning that a vast majority of the raw particles was effectively dispersed. In contrast, the D_{V}90 of the comparative sample is about 233% of its D_{N}90, this discrepancy in the size distributions that may be obtained by wet milling being further confirmed by a PDI value almost 4-fold higher than the average PDI of the three samples prepared according to the present teachings.

The size of the nanoparticles prepared and dispersed according to Example 1B and 1C were similarly determined following extraction of the nanoparticles from the matrix of the curable pre-polymers. All samples provided nanoparticles having a particle size distribution in agreement with the primary particle size of the particles from which they were size-reduced, this data being supplied by the manufacturer and independently confirmed by FIB microscopy. The particle size measured prior to dispersion were respectively of about 808 nm for the particles of titanium dioxide being dispersed in the curable melt of Example 1B and of about 149 nm for the particles of diamond being dispersed in the curable melt of Example 1C. After dispersion according to the present method, the dispersed nanoparticles displayed an average size (D_{V}50) of about 94 nm for the titanium dioxide and about 16 nm for the nanodiamonds. These findings support the efficacy of the method in deagglomerating/deaggregating particles of diverse materials into dispersed nanoparticles within various polymeric matrices.

It is noted that some of the primary particles of the titanium dioxide of Example 1B were found to consist not only of isolated primary particles, but also of sintered ones, two individual primary particles forming a neck one with the other, resulting into irregular “double” primary particles. Interestingly, a similar proportion of regular individual and sintered primary particles was found in the dispersed nanoparticles of TiO₂. This observation supports that the present method is sufficiently energic to disperse particles into nanoparticles, having in some embodiments a particle size distribution corresponding to the primary particles, the method being moderate enough not to break down primary particles into smaller fragments, as could have occurred to the sintered particles having a fragilizing neck.

### Example 3: Crystallographic Characterization of Dispersed Nanoparticles

When the nanoparticles to be dispersed have a functionality which depends on their morphological integrity and/or crystallographic structure, it may be desired to further analyse the dispersed particles by microscopic and/or crystallographic methods accordingly.

Nanoparticles extracted as described in Example 2 were placed on an aluminium pin type SEM mount covered in double sided adhesive carbon tape, dried and studied by SEM microscopy at a magnification of ×100,000 (with a Crossbeam 340 of Zeiss). As the drying resulted in apparent aggregations, this method was not used to assess the quality of the dispersion within the polymeric matrix, but the size and morphology of individual particles in a representative field-of-view. Particles embedded in a polymeric matrix by shear force as described in Example 1A displayed, following their extraction, spherical nanoparticles having a primary particle size between about 20 nm and 70 nm. When the same particles were mixed in a dissolved pre-polymer and milled by ball milling in a wet environment, the particles, the dispersant, the pre-polymer and its solvent being milled for 12 hours at 5,500 rpm in a ball mill (WAB Dyno-Mill Research lab) with 70 vol. % of zirconia beads having a diameter of 0.1-0.2 mm, the particles resulting from such impact forces were significantly deformed and fractured, globular nanoparticles being no longer detectable in a comparative field-of-view. The deformation caused by the impact forces was confirmed by XRD analysis, the “impacted” material no longer displaying the peaks characterizing the raw particles prior to their dispersion.

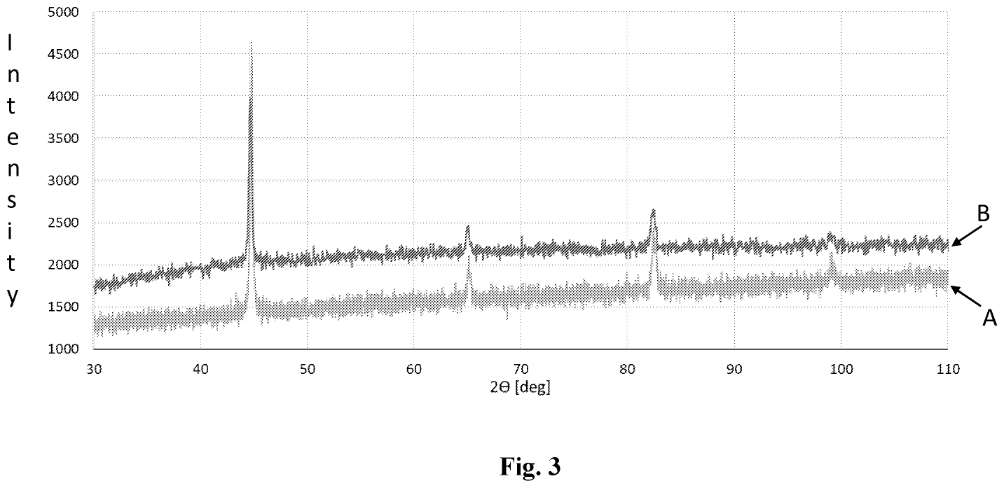

In contrast, as shown in FIG. 3, an XRD spectrum of nanoparticles “sheared” according to the present teachings display a curve B with diffraction peaks at similar locations (and relative intensities) as the raw particles before their dispersion, as depicted by curve A. The crystal structure of the nanoparticles as above-prepared was determined by powder XRD using X-ray diffractometer X'Pert Powder by Malvern Panalytical. The X-ray source (Cu anode) was operated at a voltage of 40 kV and a current of 30 mA on packed powder samples. Data were collected in continuous detector scan mode at a step size of 0.02°/step. Diffractograms were collected over the 2Θ range of 300 to 110°, the intensity being plotted on the Y-axis for each angle plotted on the X-axis.

Therefore, the present methods are effective to disperse particles into nanoparticles, while additionally maintaining the morphology and/or crystal structure of the primary particles, if so desired.

### Example 4: Curing of the Curable Melt Mix

A curable melt mix prepared according to Example 1 can be readily used to form a cured article, and can, for instance, be heat molded (e.g., injection molded or press molded) into any suitable shape (e.g., deposited on a substrate at any desired thickness) with any appropriate device. The shaped curable melt can then be cured under any conditions suiting their respective composition. However, the curing step can be delayed, in which case the curable melt mixture can first be cooled (or allowed to cool) from the temperature of its compounding to a temperature smaller than a melting temperature or a softening temperature of the melt, so as to solidify, the temperature of cooling optionally being lower than the glass transition temperature of the melt, if applicable. The solidified curable melt mixture, or solid curable mixture, can be stored until further use under storing conditions adapted to prevent curing (or further curing) to an extent rendering the stored product incompatible with future use. For instance, the storage of the solid curable mixture should be in absence of factors capable of triggering curing of the specific curable solid. Factors to be avoided during storage are in principles similar to the curing triggers to be avoided during compounding, for instance heat-curable mixtures can be stored at a temperature smaller than a glass transition temperature or a melting temperature of the curable solid melt, radiation-curable mixtures can be stored in packaging blocking the radiations relevant for curing, and so on. Following suitable storage, the stock of the solid curable mix can be melted again (re-melt) to allow its deposition on a desired support, upon or within which it can thereafter be cured. The re-melting of the mix is typically performed under conditions (e.g., of temperature) similar to those of the original melting for the sake of compounding. However, as this re-melting can be a final step prior to curing, limiting the temperature to avoid curing (if the melt is heat curable) might no longer be necessary.

The curable solid mixture can additionally be cut to batches or down-sized to any suitable forms. For instance, the curable solid can be pulverized to produce a solid powder of the curable mixture. Pulverization, or any other shaping of the curable solid should, as the compounding and optional storing step, preferably be performed in absence of factors capable of triggering curing of the specific curable solid. For the mixture to remain solid during the process, and for the mixture to be as friable as possible to enhance the efficacy of the process, pulverization should be performed at a temperature smaller/lower than a glass transition temperature or a melting temperature of the solid melt. The pulverized curable solid can be readily used to form a cured article following a suitable re-melting under conditions similar to the original preparation of the melt mixture (e.g., can serve for injection molding) or can be stored. If curing facilitators are desired, and none or only a portion were included during compounding, such materials can be added during the re-melting, as illustrated in Example 1D.

While in the above attention was drawn to the avoidance of conditions that would yield premature curing during processing of the melt mixture during its compounding and thereafter, similar concerns apply with respect to factors affecting the function of the dispersed nanoparticles. For instance, if the particles are prone to oxidation, an inert environment should be preferred for its cooling, storing, pulverizing, etc.

Regardless of the steps that can precede curing (e.g., cooling, storing, pulverizing, depositing, etc.), a curable melt as described in Example 1A, 1B and 1D can be cured for 3 hours at 180° C. in a vacuum oven. A curable melt as described in Example 1C can be cured under UV-light at a wavelength between 245 nm and 380 nm for a duration adapted to the thickness of the article, according to the guidance of the manufacturer, generally for a few minutes. Following curing, the nanoparticles previously dispersed in the curable melt are irreversibly immobilized in the cured polymer.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the present disclosure has been described with respect to various specific embodiments presented thereof for the sake of illustration only, such specifically disclosed embodiments should not be considered limiting. Many other alternatives, modifications and variations of such embodiments will occur to those skilled in the art based upon Applicant's disclosure herein. Accordingly, it is intended to embrace all such alternatives, modifications and variations and to be bound only by the spirit and scope of the disclosure and any change which come within their meaning and range of equivalency.

In the description and claims of the present disclosure, each of the verbs “comprise”, “include” and “have”, and conjugates thereof, are used to indicate that the object or objects of the verb are not necessarily a complete listing of features, members, steps, components, elements or parts of the subject or subjects of the verb. Nevertheless, it is contemplated that the compositions of the present teachings also consist essentially of, or consist of, the recited components, and that the methods of the present teachings also consist essentially of, or consist of, the recited process steps.

As used herein, the singular form “a”, “an” and “the” include plural references and mean “at least one” or “one or more” unless the context clearly dictates otherwise. As used herein, the term at least one of A and B is intended to mean either A or B, and may mean, in some embodiments, A and B.

Unless otherwise stated, the use of the expression “and/or” between the last two members of a list of options for selection indicates that a selection of one or more of the listed options is appropriate and may be made.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

As used herein, unless otherwise stated, adjectives such as “substantially”, “approximately” and “about” that modify a condition or relationship characteristic of a feature or features of an embodiment of the presently disclosed subject matter, are to be understood to mean that the condition or characteristic is defined to within tolerances that are acceptable for operation of the embodiment for an application for which it is intended, or within variations expected from the measurement being performed and/or from the measuring instrument being used. For example, when the term “about” or “approximately” precedes a numerical value, it may indicate +/−15%, or +/−10%, or even only+/−5%, or any other suitable +/− variation within such ranges, and in some instances may indicate the precise value. Furthermore, unless otherwise stated, the terms (e.g., numbers) used in an embodiment of the presently disclosed subject matter, even without such adjectives, should be construed as having tolerances which may depart from the precise meaning of the relevant term but would enable the embodiment or a relevant portion thereof to operate and function as described, and/or as understood by a person skilled in the art.

Unless otherwise stated, when the outer bounds of a range with respect to a feature of an embodiment of the present technology are noted in the disclosure, it should be understood that in the embodiment, the possible values of the feature may include the noted outer bounds as well as values in between the noted outer bounds.

Certain marks referenced herein may be common law or registered trademarks of third parties. Use of these marks is by way of example and shall not be construed as descriptive or limit the scope of this disclosure to material or chemical equivalents thereof associated only with such marks. For illustration, the phosphate ester dispersant commercially available from ILCO Chemikalien as ILCO PHOS 204, could be replaced by Crodafos™ 810A by Croda Industrial Chemicals; and the curable epoxy resin commercially available from Dic Corporation as Epiclon® N-695, could be replaced by Epiclon® N-680, Epon™ Resin 164 or Epon™ Resin 165 by Hexion Inc.; or by any other commercially available or independently prepared equivalent.

1. A method for stably dispersing nanoparticles of a material in a curable pre-polymer, the method comprising:
a) providing a curable thermoplastic pre-polymer;
b) providing particles of the material, the material having a density of 2.2 g/cm³ or more; and
c) compounding the curable pre-polymer and the particles at at least one compounding temperature sufficiently high to obtain a melt mixture and sufficiently low for the melt mixture to develop a pre-determined viscosity upon compounding, the melt mixture having a compounding temperature not exceeding 400° C. and being substantially devoid of a solvent capable of dissolving the curable thermoplastic pre-polymer;
wherein the compounding is performed by applying substantially only a shear force to the melt mixture, the shear force being such that the particles are reduced to nanoparticles and the pre-determined viscosity being such that the nanoparticles are dispersed in the mixture, the dispersed nanoparticles having an average particle size (D_{V}50 or D_{N}50) of 100 nm or less, 75 nm or less, or less 50 nm or less.

2. A method as claimed in claim 1, wherein the particles provided for compounding are aggregates or agglomerates of primary particles, the primary particles having an average particle size (D_{V}50 or D_{N}50) of 100 nm or less, 75 nm or less, or 50 nm or less.

3. A method as claimed in claim 1, wherein the at least one compounding temperature is:
I. equal to or higher than at least one of: a glass transition temperature of the curable thermoplastic pre-polymer, a softening temperature of the curable thermoplastic pre-polymer, a melting temperature of the curable thermoplastic pre-polymer, a glass transition temperature of the melt mixture, a softening temperature of the melt mixture, and a melting temperature of the melt mixture;
II. lower by at least 20 C° than at least one of: a curing temperature of the curable thermoplastic pre-polymer and a curing temperature of the melt mixture;
III. higher than 30° C., higher than 50° C., higher than 70° C., or higher than 90° C.; and
IV. lower than 350° C., lower than 300° C., lower than 250° C. or lower than 200° C.

4. A method as claimed in claim 1, wherein the curable thermoplastic pre-polymer and/or the melt mixture obtained therewith fulfils one or more of the following structural properties:
a) the pre-polymer or melt mixture has a glass transition temperature (Tg) of −80° C. or more, −40° C. or more, 0° C. or more, or at least 30° C., at least 50° C., at least 70° C., or at least 90° C.;
b) the pre-polymer or melt mixture has a Tg of at most 260° C., at most 240° C., at most 220° C., at most 200° C., at most 180° C., or at most 160° C.;
c) the pre-polymer or melt mixture has a softening temperature (Ts) of at least 30° C., at least 50° C., at least 70° C., or at least 90° C.;
d) the pre-polymer or melt mixture has a Ts of at most 260° C., at most 240° C., at most 220° C., at most 200° C., at most 180° C., or at most 160° C.;
e) the pre-polymer or melt mixture has a melting temperature (Tm) of at least 30° C., at least 50° C., at least 70° C., or at least 90° C.;
f) the pre-polymer or melt mixture has a Tm of at most 260° C., at most 240° C., at most 220° C., at most 200° C., at most 180° C., or at most 160° C.; and
g) the pre-polymer or melt mixture has a melt flow index (MFI) between 0.01 and 10.

5. A method as claimed in claim 1, wherein the pre-determined viscosity of the melt mixture is at least 0.1 kiloPascal-second (kPa·s), at least 1 kPa·s, or at least 10 kPa·s, at the at least one compounding temperature; and optionally no more than 500 kPa·s.

6. A method as claimed in claim 1, wherein the particles are provided at a weight ratio of 10:1 or less, 5:1 or less, or 2:1 or less, by weight of the curable thermoplastic pre-polymer.

7. A method as claimed in claim 1, wherein the dispersed nanoparticles have at least one particle size as follows:
a—the nanoparticles have an average particle size (D_{V}50 or D_{N}50) of at least 20 nm, at least 25 nm, at least 30 nm, or at least 35 nm;
b—the nanoparticles have an average particle size (D_{V}50 or D_{N}50) between 20 nm and 100 nm, between 25 nm and 100 nm, between 30 nm and 80 nm, or between 35 nm and 60 nm;
c—the nanoparticles have a minimal particle size (D_{V}1 or D_{N}1) of at least 5 nm, at least 10 nm, or at most 15 nm; and
d—the nanoparticles have a maximal particle size (D_{V}99 or D_{N}99) of at most 200 nm, at most 180 nm, or at most 160 nm.

8. A method as claimed in claim 1, wherein the dispersed nanoparticles form a population having at least one particle size distribution as follows:
a—a size distribution of 80% of the population (from D_{V}10 to D_{V}90, or from D_{N}10 to D_{N}90) between 20 nm and 200 nm, between 25 nm and 180 nm, or between 30 nm and 160 nm;
b—a size distribution of 90% of the population (from D_{V}5 to D_{V}95, or from D_{N}5 to D_{N}95) between 20 nm and 200 nm, between 25 nm and 180 nm, or between 30 nm and 160 nm;
c—a size distribution of 98% of the population (from D_{V}1 to D_{V}99, or from D_{N}1 to D_{N}99) between 20 nm and 200 nm, between 25 nm and 180 nm, or between 30 nm and 160 nm;
d—a size distribution of 99.8% of the population (from D_{V}0.1 to D_{V}99.9, or from D_{N}0.1 to D_{N}99.9) between 20 nm and 200 nm, between 25 nm and 180 nm, or between 30 nm and 160 nm;
e—a difference between the hydrodynamic diameter of 90% of the nanoparticles and the hydrodynamic diameter of 10% of the nanoparticles, as can be set by number or by volume, is equal to or less than 180 nm, equal to or less than 150 nm, or equal to or less than 100 nm, or equal to or less than 50 nm, which can be mathematically expressed by: (D90−D10)≤180 nm and so on;
f—a ratio between a) the difference between the hydrodynamic diameter of 90% of the nanoparticles and the hydrodynamic diameter of 10% of the nanoparticles; and
b) the hydrodynamic diameter of 50% of the nanoparticles, as can be set by number or by volume, is no more than 2.0, or no more than 1.5, or no more than 1.0, which can be mathematically expressed by: (D90−D10)/D50≤2.0 and so on; and
g—a polydispersity index (PDI) of the nanoparticles is equal to or less than 0.4, equal to or less than 0.3, equal to or less than 0.2, or equal to or less than of 0.15, the PDI optionally being equal to 0.01 or more, 0.05 or more, or 0.1 or more.

9. A method as claimed in claim 1, wherein the dispersed nanoparticles form a population having a particle size distribution of 80% of the population (from D_{V}10 to D_{V}90, or from D_{N}10 to D_{N}90) between 20 nm and 200 nm, between 25 nm and 180 nm, or between 30 nm and 160 nm; and having a PDI of 0.1 or less, the PDI optionally being equal to 0.01 or more.

10. A method as claimed in claim 1, wherein the dispersed nanoparticles include primary particles having at least one of a morphology, a crystal structure and a function substantially similar to a respective morphology, crystal structure and function of primary particles of the particles provided for compounding.

11. A method as claimed in claim 1, wherein the curable thermoplastic pre-polymer is selected from a group comprising shellacs, rosins, acrylic resins, epoxy resins, phenol resins, polyurethane resins, silicone resins, co-polymers thereof, and combinations thereof.

12. A method as claimed in claim 1, wherein the curable thermoplastic pre-polymer includes a moiety having affinity to the nanoparticles.

13. A method as claimed in claim 1, wherein the particles include, consist or consist essentially of an organic or inorganic material selected from a group comprising metals, metal oxides, alloys, ceramics, semiconductors, carbon-based materials, natural or synthetic polymers, and pigments.

14. A method as claimed in claim 1, wherein the dispersed nanoparticles have a function selected from a group comprising a mechanical function, a thermal function, an electrical function, an optical function, a detecting function, a magnetic function and combinations thereof.

15. A method as claimed in claim 1, further comprising providing a dispersant selected and adapted to disperse the particles in the curable thermoplastic pre-polymer.

16. A method as claimed in claim 15, wherein the dispersant is provided at a weight ratio of 0.3:1 to 3:1 by weight of the curable thermoplastic pre-polymer, and/or the dispersant (or a blend thereof) is provided at a weight ratio of 1:3 or less, 1:5 or less, 1:10 or less, 1:15 or less, 1:20 or less, 1:25 or less, or 1:30 or less, by weight of the particles, provided that the melt mixture further comprising the dispersant has at least one of a Ts and Tm of 30° C. or more.

17. A method as claimed in claim 1, further comprising providing at least one of a curing agent and a curing accelerator, each being selected and adapted to the curable thermoplastic pre-polymer and one to the other, if present, the curing agent and/or curing accelerator being provided during or after compounding.

18. A method as claimed in claim 17, wherein the at least one curing agent is provided at a weight ratio of 0.1:1 to 1:1 by weight of the curable thermoplastic pre-polymer and/or the at least one curing accelerator is provided at a weight ratio of 0.01:1 to 0.1:1 by weight of the curable thermoplastic pre-polymer, provided that the melt mixture further comprising at least one of a dispersant, a curing agent and a curing accelerator has at least one of a Ts and Tm of 30° C. or more.

19. A method as claimed in claim 1, wherein the melt mixture is substantially devoid of a solvent further capable of dissolving any constituent of the mixture other than the curable thermoplastic pre-polymer, said constituent being at least one of a dispersant, a curing agent and a curing accelerator.

20. A method as claimed in claim 1, further comprising following compounding at least one of the following steps:
A] cooling the curable melt mixture or letting the melt cool to a temperature smaller than a melting temperature or a softening temperature of the melt, so as to solidify the curable melt;
B] pulverizing a solidified curable melt mixture, the pulverization being at a temperature smaller than a glass transition temperature or a melting temperature of the solid melt, so as to produce a solid powder of the curable melt;
C] storing a solidified curable melt mixture, optionally pulverized, the storing being at a temperature smaller than a glass transition temperature or a melting temperature of the solid melt, and in absence of factors capable of curing the solid curable melt or powder thereof;
D] depositing the melt mixture, optionally formed from re-melting of pulverized and/or un-stored solid powders or mixtures, on a substrate; and
E] curing the deposited melt mixture on a substrate so as to irreversibly immobilize the dispersed nanoparticles in a cured polymer.

21. A method as claimed in claim 20, wherein the curing is performed following separation of the deposited melt mixture from the substrate.
